(19) United States
(12) Patent Application Publication
(10) Pub. No.: US 2025/0284955 A1
(43) Pub. Date: Sep. 11, 2025

(54) Classification of Global Cell Proliferation Based on Deep Learning

(71) Applicant: UNIVERSITY OF SOUTH FLORIDA, Tampa, FL (US)

(72) Inventors: Hunter Hugh MORERA, Tampa, FL (US); Dmitry B GOLDGOF, Tampa, FL (US); Lawrence O’Higgins HALL, Tampa, FL (US)

(21) Appl. No.: 18/889,355

(22) Filed: Sep. 18, 2024

Related U.S. Application Data
(63) Continuation of application No. PCT/US2023/015690, filed on Mar. 20, 2023.
(60) Provisional application No. 63/321,557, filed on Mar. 18, 2022.

(51) Int. Cl. G06N 3/08; G06N 3/0464; G06V 20/70

(52) U.S. Cl. CPC G06N 3/08; G06N 3/0464; G06V 20/70

(57) ABSTRACT

A method for automatic classification is disclosed. The method includes: training a deep learning model with a first set of a plurality of local images of first cells of a first tissue with a low magnification equal to or less than 40×; inputting a runtime image including second cells of a second tissue corresponding to the first tissue with the low magnification equal to less than 40× in the deep learning model; and automatically classifying a total number of the runtime cells in the runtime image as a proliferation level based on an output of the trained deep learning model. Other aspects, embodiments, and features are also claimed and described.

### CROSS-REFERENCE TO RELATED APPLICATION(S)

This US patent application is a continuation of the pending International Application No. PCT/US2023/015690 filed on Mar. 20, 2023, which claims the benefit of U.S. Provisional Patent Application Ser. No. 63/321,557, filed Mar. 18, 2022, the disclosures of each of which is hereby incorporated by reference in its entirety, including all figures, tables, and drawings.

### STATEMENT OF GOVERNMENT SUPPORT

This invention was made with government support under 1R01AG055523 awarded by the National Institutes of Health, and under 1513126 and 1746511 awarded by the National Science Foundation. The government has certain rights in the invention.

### TECHNICAL FIELD

The technology discussed below relates to training of deep learning models for classifying characteristics of materials in images acquired at different distance, perspective, scale, zoom, or magnification. In some examples, deep learning models may be used for quantification or classification of cell proliferation.

### BACKGROUND

In basic science and clinical studies using current techniques, quantification or classification of detailed characteristics of materials in images (e.g., cell counts for microglial proliferation) requires extensive manual counting (e.g., cell clicking) by trained experts (up to 2 hours per case). High magnification images are thus required, which results in multiple images needing to be acquired for certain types of slides in order to cover all content of the slides at high magnification. Each slide is then reviewed by the experts. Thus, current processes are time consuming and require review of more images. What are needed are systems and methods that address one or more of these shortcomings.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method, a system, and/or an apparatus for automatic classification is disclosed. The method, the system, and/or the apparatus include: obtaining a deep learning model, the deep learning model having been trained with a first set of a plurality of local images of first cells of a first tissue with a low magnification equal to or less than a 40× objective lens. The first set of the plurality of local images have a ground truth label based on a number of the first cells counted at a high magnification equal to or higher than a 60× objective lens. The method, the system, and/or the apparatus further include: inputting a runtime image including second cells of a second tissue corresponding to the first tissue with the low magnification in the deep learning model, and automatically classifying a total number of the runtime cells in the runtime image as a proliferation level based on an output of the trained deep learning model.

In other examples, rather than differences in magnification, images of objects may differ in related aspects such as zoom, scale, or distance from which the image was taken relative to the imaged objects.

These and other aspects of the invention will become more fully understood upon a review of the detailed description, which follows. Other aspects, features, and embodiments of the present invention will become apparent to those of ordinary skill in the art, upon reviewing the following description of specific, example embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while example embodiments may be discussed below as device, system, or method embodiments it should be understood that such example embodiments can be implemented in various devices, systems, and methods.

### BRIEF DESCRIPTION OF THE DRAWINGS

FIG. 1 is an illustration of an example network architecture for automatic classification according to some aspects of the disclosure.

FIG. 2 is an illustration of an example boundary of center cropped image with a box according to some aspects of the disclosure.

FIG. 3 illustrates training images with augmentation techniques according to some aspects of the disclosure.

FIG. 4A is an illustration of ground truth labels in a high-density image. FIG. 4B is an illustration of ground truth labels in a low-density image according to some aspects of the disclosure.

FIG. 5A is another illustration of ground truth labels in a high-density image. FIG. 5B is another illustration of ground truth labels in a low-density image according to some aspects of the disclosure.

FIG. 6A is another illustration of ground truth labels in a high-density image. FIG. 6B is another illustration of ground truth labels in a low-density image according to some aspects of the disclosure.

FIG. 7 is an illustration of unknown test case stereology count estimation at 20× magnification based on the number of cells sorted into bins ground truth stereology count at 100× magnification.

FIG. 8 is a flow chart illustrating an example process for automatic classification in a training phase according to some aspects of the disclosure.

FIG. 9 is a flow chart illustrating an example process for automatic classification in a runtime phase according to some aspects of the disclosure.

FIG. 10 is a block diagram conceptually illustrating an example of a hardware implementation for the methods disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Microglial cell proliferation in neural tissue (neuroinflammation) occurs during infections, neurological disease, neurotoxicity, and other conditions. In basic science and clinical studies, quantification of microglial proliferation requires extensive manual counting (cell clicking) by trained experts (up to 2 hours per case). Previous efforts to automate this process have focused on stereology-based estimation of global cell number using deep learning (DL)-based segmentation of immunostained microglial cells at high magnification. To further improve on throughput efficiency, this disclosure discloses a novel approach using snapshot ensembles of convolutional neural networks (CNN) with training using local images, i.e., low (e.g., 20×) magnification, to predict high or low microglial proliferation at the global level. For example, an expert may use stereology to quantify the global microglia cell number at high magnification, apply a label of high or low proliferation at the animal (mouse) level, then assign this global label to each low magnification (e.g., 20×) image as ground truth for training a CNN to predict global proliferation. To test accuracy, cross validation with six mouse brains from each class for training and one each for testing was done. The ensemble predictions were averaged, and the test brain was assigned a label based on the predicted class of the majority of images from that brain. The ensemble accurately classified proliferation in 11 of 14 brains (˜80%) in less than a minute per case, without cell-level segmentation or manual stereology at high magnification. This approach shows, for the first time, that training a deep learning model with local images can efficiently predict microglial cell proliferation at the global level. It should be appreciated that the example classification method can be done with only snapshot ensembles of multiple network models. Of course, the example classification method can be done with a single network model.

A wide range of basic research and drug discovery studies may use quantification of microglial cell proliferation on stained tissue sections to better understand and treat neurological conditions. In some examples, quantitative studies of microglial proliferation, i.e., increased microglia cells in an anatomically defined region of interest, are done by a well-trained data collector using computer-assisted stereology methods. However, a simple quantification of microglia cell proliferation in a single mouse brain region might use two hours for analyzing stained tissue sections. Further limitations are that the data generated by these studies are prone to low inter-rater agreement due to human factors such as subjective decision-making, variable training and experience of data collectors, fatigue, etc. Machine Learning may offer a variety of automatic approaches to enhance the accuracy, reproducibility, and efficiency of assessing microglial cell proliferation on stained tissue sections while reducing the human involvement for this work.

In some examples, one of the first methods to automate stereology methods may use a hand-crafted Adaptive Segmentation Algorithm (ASA) for segmenting cells at high magnification (60× to 100×). This method may use a Gaussian Mixture Model (GMM), morphological operations, Voronoi diagrams, and watershed segmentation for automatic cell counts on extended depth of field (EDF) images created from volumes of z-axis stacks as input. Early applications of this method show reasonable performance with an error rate of around 11%, high reproducibility and 5× increases in throughput relative to manual stereology counts. In further examples, all performance metrics can be improved with the development of a deep learning (DL) approach to perform the cell-level segmentations for calculation of total cell number using the unbiased optical fractionator method. In some instances, CNNs can be used for segmentation of brain cells (NeuN-immunostained neurons) in the neocortex (NCTX) of mouse brains. This method may use ASA to automatically generate and verify masks which are then used to train a U-Net model to segment cells with post-processing according to unbiased cell counting rules to make stereology-based estimates of total number. This approach may use an iterative deep learning technique in which a trained human expert verifies previous predictions that are then used for training the image sets of subsequent models. This work may show that within five iterations the error rate difference compared to a trained professional fell to below 1%, i.e., less than a tenth of the error by the ASA method. Though the CNN performed well for segmenting cells at high magnification, the iterative deep learning process still uses extensive human-in-the-loop input to verify the ASA-generated masks. For many studies focused on assessing microglial cell proliferation, a simple automatic classification of global proliferation based on low magnification images would be an attractive alternative to automatic segmentation of cells at high magnification. This is particularly true for quantifying changes such as proliferation at a global level in response to functional changes, e.g., inflammation, malignancy, rather than fine changes at the cellular and subcellular levels.

To address this issue, an example model can be trained with low magnification images (20×) of Iba1-immunostained microglia cells using a snapshot ensemble of CNNs to classify the proliferation of the total number of microglia cells in the NCTX of mouse brains. The model can classify each image as belonging to low or high total numbers of microglial cells at the global level in NCTX, without the need for human-in-the-loop training, cell-level segmentation, or manual stereology at high magnification. Because the approach uses little effort or technical expertise by the data collector, it has the potential to accelerate the throughput of microglial proliferation studies in many scientific disciplines.

Animal tissues for this example may be the Dp16 mouse model of Down syndrome (trisomy Hsa21) with APP gene overexpression; and sex- and age-matched littermate controls (2N). Serial 40 μm-thick sections may be cut through the entire NCTX and stained using standard Iba-1 immunostaining to label microglial cells. The total number of Iba-1 microglial cells in NCTX may be quantified by an expert technician using the manual version of the unbiased optical fractionator6 in a computerized stereology system (e.g., Stereologer). Cases may be sorted from high to low proliferation based on the total number of microglial cells, and seven (7) cases can be selected from each extrema, i.e., n=7 cases each with the highest and lowest total number of microglial cells in NCTX. For the low cases the total number of cells ranged from 405,200 to 452,550 and for the high cases from 638,670 to 714,740. From these cases an image dataset may be automatically collected at 20× magnification in a systematic-random set of sections through each NCTX. A minimum of 380 low magnification (20×) fields of microglia cells may be imaged at systematic-random locations in about 15 sections through NCTX of each brain. Each case (mouse brain) may receive a ground truth (GT) label of either high or low proliferation of microglia cells, i.e., high or low total number of cells in NCTX, with the same label applied to all images from that brain. Images may be not individually labeled as high or low total number of cells due to the difficulty, if not the impossibility, of doing so even with a minimal level of confidence by a well-trained expert.

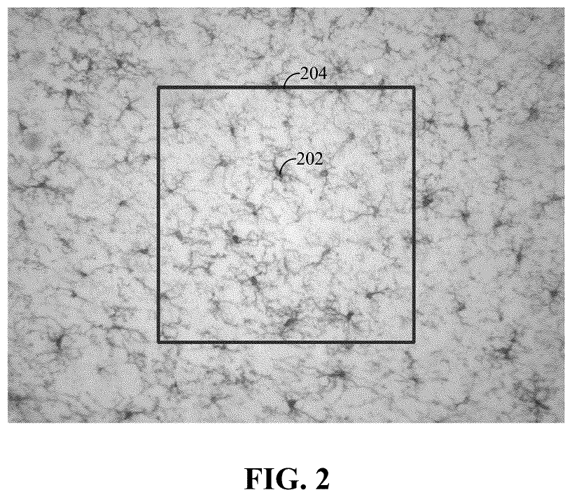

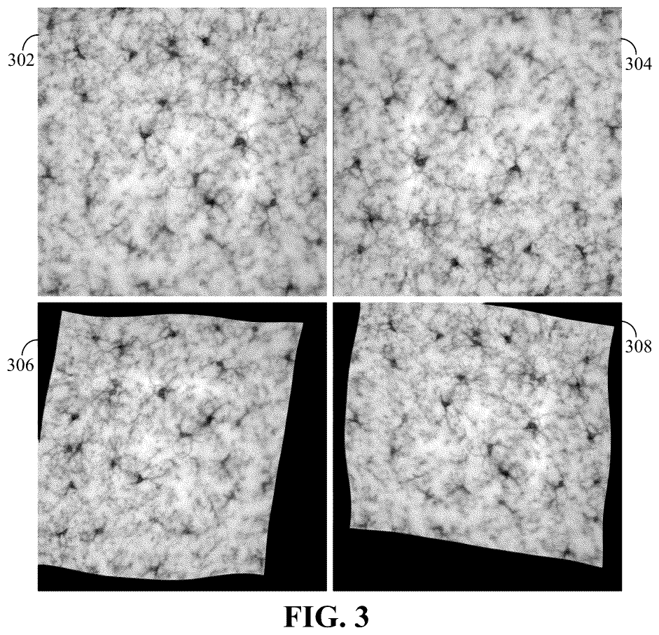

Pre-processing may include color thresholding to remove all images that contained less than 50% tissue in frame and center cropping to a size of 512×512 pixels for input to the CNN to eliminate the blurring effect as shown in FIG. 2. FIG. 2 shows an example of routinely captured image of microglia in neocortex using 20× objective. In some examples, the cells 202 are labeled as ground truth (dark gray). The box shows a boundary 204 of the center cropped image. The images may be further pre-processed to convert from RGB to grayscale using a correlation-based approach. The method may be assessed by cross validation with training on n=5 cases from each class, validated on n=1 from each class, and tested on n=1 from each class. Finally, to increase the quantity of training data, all training images may be augmented with two elastic deformations and/or rotation by 90, 180, and 270 degrees as shown in FIG. 3. In some examples, multiple training images can be produced from an original image. For example, an original image 302 may be a first training image. A second training image may be a 180-degree rotated image 304 from the original image 302. A third training image may be an elastically deformed image 306 from the original image 302. A fourth training image may be an elastically deformed and 90-degree rotated image 308 from the original image 302. Thus, at least four training images can be generated from one original image.

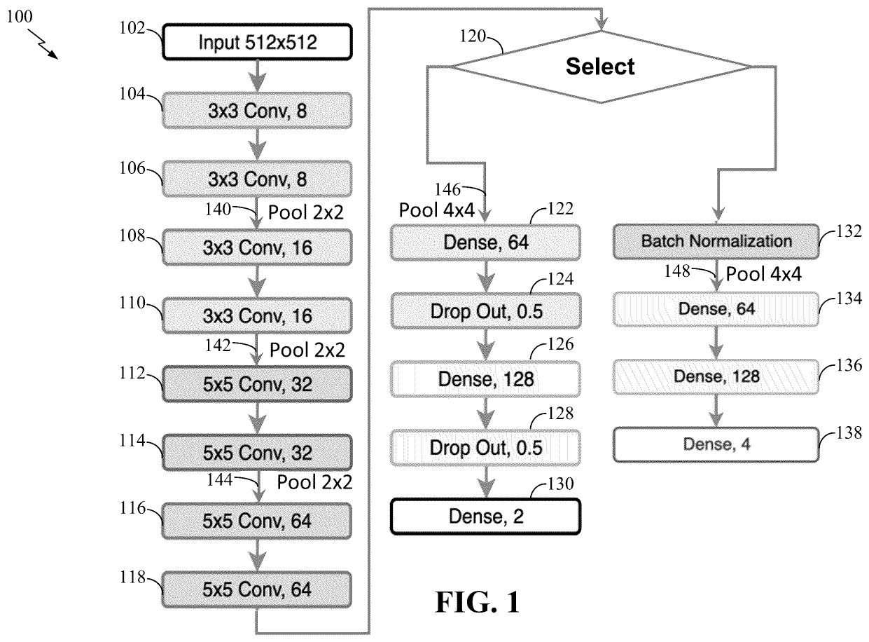

In some embodiments, modified versions of CNN architectures based on approaches such as VGG16 and DenseNet could be used; however the inventors found that performance obtained when using these architectures was low due to the large number of parameters in these models. Therefore, a custom CNN architecture can be developed (e.g., in Keras with TensorFlow backend), as shown in FIG. 1. For example, the custom CNN architecture 100 may provide one of two classes or one of more than two classes (e.g., four classes). The custom CNN architecture 100 for two classes can include at least one layer 104-118, at least one max pooling layer 140-146, at least one dense layer 122, 126, 130, and at least one dropout layer 124, 128. The custom CNN architecture 100 for more than two classes (e.g., four classes) can include at least one layer 104-118, at least one max pooling layer 140-144, 148, at least one dense layer 134, 136, 138, and a batch normalization layer 132.

In some examples, a convolution layer 104-118 receives an image (2D matrix) as an input and takes parameter of size of filter N×N and number of filters K. It then generates K random filters of size N×N and convolves them with each pixel in the input matrix, except for on the border where there are not enough pixels to compute the convolution. Thus, it decreases the size of an input by N−1. Thus, a filter of 3×3 will reduce an image size by 3-1 (i.e., reduce image size by 2 pixels).

A max pooling layer 140-148 receives an image (2D matrix) as input and takes a parameter of size N×N. It then applies the max pooling by looking at each N×N section of the image and only retaining the largest value in that window. It repeats this for every pixel in the image. This reduced the image size by a factor of N. Thus, if there is a pooling layer of 2×2, the output will be the input size divided by 2.

A dense layer 1220, 126, 130, 134-138 includes a set of perceptron's and is the neural network part of a Convolution Neural Network. It receives an input of a 1-dimensional feature vector and includes K number of nodes. Those nodes have a weight and bias that is updated through back propagation. These weights and biases are applied to the input and passed through an activation function to produce an output.

A dropout layer 124, 128 is a type of regularization that is used to prevent overfitting in a neural network. It takes a parameter of percent of neurons to dropout. It then randomly removes that percentage of the connections in a dense layer to reduce overfitting and make the network generalize better.

A batch normalization layer 132 can optionally be used to normalize all the inputs from a mini-batch or a batch of training data prior to operating on it with a subsequent layer. This standardizes the inputs to the subsequent layer which can stabilize the training and reduce the number of epochs needed to train a network. For embodiments using this normalization, the first and the second statistical moments (mean and variance) of the current batch can be used. In some examples, the batch normalization layer 132 normalizes its output using the mean and standard deviation of the current batch of inputs.

In some examples, the custom CNN architecture 100 may perform an example process as presented below.

In block 102, an input image is transmitted to a first convolution layer 104. The input image may have the input size of 512×512 grayscale with a single channel.

In block 104, the first convolution layer 104 receives the input image 102. The first convolution layer is 3×3 with 8 filters, it takes the input of 512×512 and outputs 8 images of size 510×510 that are then passed to the second convolution layer 106.

In block 106, a second convolution layer 106 receives 8 images of size 510×510. The second convolution layer is 3×3 with 8 filters. The second convolution layer 106 takes the input of 510×510 and outputs 8 images of size 508×508 that are then passed to the first max pooling layer 130.

In block 140, the first max pooling layer 140 is of size 2×2. The first max pooling layer 140 receives the 8 images of size 508×508 and performs the pooling to produce 8 images of size 254×254 and then passes to the third convolution layer 108.

In block 108, the third convolution layer 108 is 3×3 with 16 filters. The third convolution layer 108 receives the input of 8 images of size 254×254 and outputs 16 images of size 252×252 that are then passed to the fourth convolution layer 110.

In block 110, the fourth convolution layer 110 is 3×3 with 16 filters. The fourth convolution layer 110 receives the input of 16 images of size 252×252 and outputs 16 images of size 250×250 that are then passed to the second max pooling layer 132.

In block 142, the second max pooling layer 142 is of size 2×2. The second max pooling layer 142 receives the 16 images of size 250×250 and performs the pooling to produce 16 images of size 125×125 and then passes to the fifth convolution layer 112.

In block 112, the fifth convolution layer 112 is 5×5 with 32 filters. The fifth convolution layer 112 receives the input of 16 images of size 125×125 and outputs 32 images of size 121×121 that are then passed to the sixth convolution layer 114.

In block 114, the sixth convolution layer 114 is 5×5 with 32 filters. The sixth convolution layer 114 receives the input of 32 images of size 121×121 and outputs 32 images of size 117×117 that are then passed to the third max pooling layer 134.

In block 144, the third max pooling layer 144 is of size 2×2. The third max pooling layer 144 receives the 32 images of size 117×117 and performs the pooling to produce 32 images of size 58×58 and then passes to the seventh convolution layer 116.

In block 116, the seventh convolution layer 116 is 5×5 with 64 filters. The seventh convolution layer 116 receives the input of 32 images of size 58×58 and outputs 64 images of size 54×54 that are then passed to the eighth convolution layer 118.

In block 118, the eighth convolution layer 118 is 5×5 with 64 filters. The eighth convolution layer 118 receives the input of 64 images of size 54×54 and outputs 64 images of size 50×50 that are then passed to the fourth max pooling layer 136.

In block 120, one of two algorithms is determined. For example, blocks 120-130 or blocks 132-138 can be determined. In some examples, blocks 132-138 can be selected at default unless any intervention is received to select blocks 120-130. In other examples, blocks 120-130 are optional. In the examples in FIG. 1, blocks 120-130 produce one of two output classes while blocks 132-138 produce one of four output classes. However, blocks 120-130 or blocks 132-138 can be used to produce any other feature vector (e.g., 2, 3, or any other suitable feature vector).

When the output classes are two, block 146 is performed after block 118 is performed. In block 146, the fourth max pooling layer 146 is of size 4×4. The fourth max pooling layer 146 receives the 64 images of size 50×50 and performs the pooling to produce 64 images of size 12×12 and then passes to the first dense layer 120. Before going to the first dense layer 120, the 2D matrix is flattened into a 1D matrix of size 12×12×64=9216 features.

In block 122, the first dense layer 122 includes 64 neurons and processes the feature vector of size 9216.

In block 124, dropout 124 is then performed on the first dense layer where 50% of the connections are dropped.

In block 126, the output of the first dense layer 122 of 64 neurons is then passed to the second dense layer 126 of 128 neurons and process the feature vector.

In block 128, dropout 128 is then performed on the second dense layer where 50% of the connections are dropped.

In block 130, finally, the output of the second dense layer 126 is passed to a third dense layer 130 with only 2 neurons, producing a feature vector of 2. This feature vector is then processed with softmax activation. This determines the class of the image, either high or low density (i.e., one of two classes) based on which of the two features in the vector has the largest value.

When the output classes are more than two (e.g., four classes), block 132 is performed after block 118 is performed. In block 132, the batch normalization layer is optionally performed.

In block 144, the fifth max pooling layer 148 is of size 4×4. The max pooling layer 148 can be used for down sampling of a feature map. It calculates the maximum value for a specific patch of the feature map it is applied to. An example is a 4×4 max pooling layer looks at the input feature map (2D) and takes every 4×4 patch and reduces it down to a single number, that number being the max value in the 4×4 patch. In some examples, the max pooling layer 148 can down sample the input along its spatial dimensions (height and width) by taking the maximum value over an input window (of size defined by pool_size) for each channel of the input. The window is shifted by strides along each dimension.

In block 134, the fourth dense layer 134 includes 64 neurons. The convolution and pooling layers help reduce the feature space of the input image. The reduced features are then passed to dense layers which include multiple neurons (perceptrons). Dense layers use a weight and bias that are updated throughout training to perform the classification from the reduced feature vector produced by the convolution and pooling layers. In some examples, the dense layer can implement the operation: output=activation(dot(input, kernel)+bias) where activation is the element-wise activation function passed as the activation argument, kernel is a weights matrix created by the layer, and bias is a bias vector created by the layer.

In block 136, the output of the fourth dense layer 134 of 64 neurons is then passed to the fifth dense layer 136 of 128 neurons and process the feature vector.

In block 138, the output of the fifth dense layer 136 is passed to the sixth dense layer 138 with more than two neurons (e.g., four neurons), producing a feature vector of 2. This feature vector is then processed with softmax activation. This determines the class of the image (e.g., one of four classes) based on which of the two features in the vector has the largest value. It should be appreciated that the number of classes for a proliferation level of a total number of cells in an image can be any other suitable number (e.g., three, five, six, seven, etc.) if each output class of the deep learning model can be properly trained with training images with a ground truth label corresponding to the respective output class.

It is to be understood that the size of the layers (including, for example, the numbers of neurons in dense layers, or the patch size in pooling layers) may be adjusted depending upon the input image characteristics (e.g., size, coloration, etc.), number of output classes, desired speed/computation required, etc.

In some examples, all convolution layers may use ReLU activation, two fully connected layers may use ReLU with the addition of L2 regularization, the output may consist of a softmax activation function, and finally the model may be trained (e.g., using Stochastic Gradient Descent (SGD)) for optimization. To enhance performance, the snapshot ensemble approach can be used with a cyclic learning rate in the form of cosine annealing to produce variability in the models as training proceeds. This technique allows for training a single time and saving intermediate models, which then can be used in an ensemble without the need for training the model multiple times. In some examples, 110 epochs are trained with a cycle of 10 epochs and a maximum learning rate of 0.004. This approach may produce 11 models used to predict on the images then those 11 predictions may be averaged for a final classification.

In some examples, the disclosed model correctly predicts whether microglial cell proliferation exists at the global level, i.e., in the mouse NCTX, based on ensemble training with local images of microglia cell densities at low (20×) magnification. The correct labeling is based on the known proliferation of microglial cells in NCTX from a priori stereology studies using the ordinary optical fractionator method with manual counting at high magnification. A threshold of 50% of animal images belonging to a single class may be used to assign the class when testing. The reason for this assignment strategy is that not all low magnification fields of microglia cells are expected to match its global class label, the class assigned to each mouse may use at least half of the total images of microglial cells in NCTX to be automatically classified as either high or low proliferation at the global level. The 50% threshold for assigning the global label avoids misclassifying cases where the label does not match many images within a mouse.

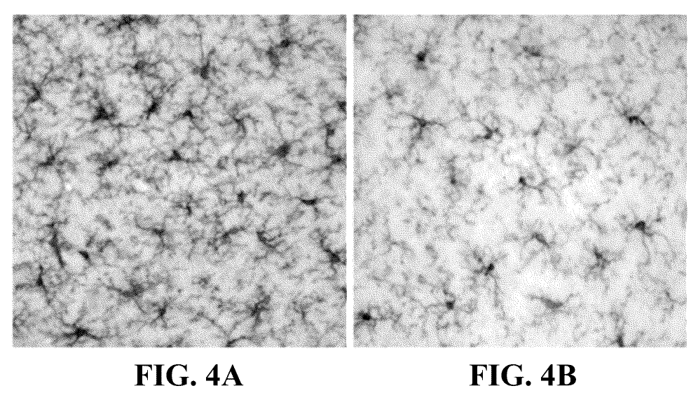

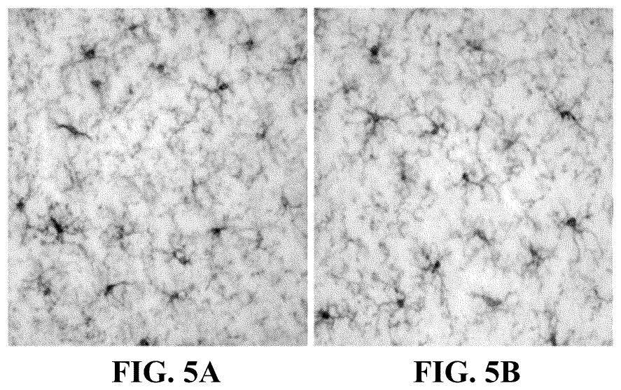

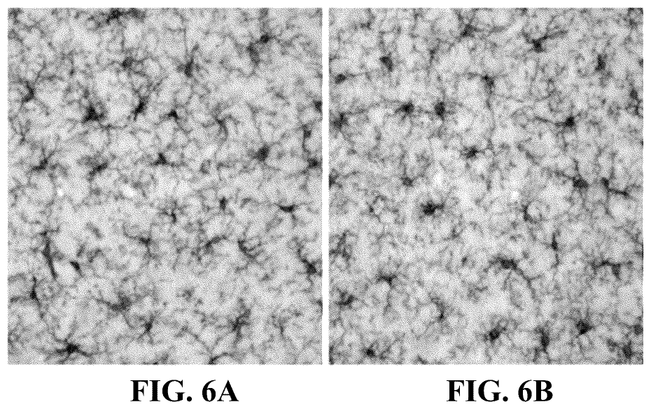

For instance, FIGS. 4A and 4B show examples of images where local densities appear to fit their training labels with high proliferation on the left and low proliferation on the right. FIG. 4A shows ground truth labels for a high density image, while FIG. 4B shows ground truth labels for a low density image. In contrast, FIGS. 5A and 5B show two images with high and low proliferation at the global level, respectively, though they both appear to be low density at the local level. Similarly, in FIGS. 6A and 6B, two images are shown with high and low proliferation at the global level, respectively, though they both appear to be high density at the local level.

The example model for this classification issue may use the snapshot ensemble to improve performance. One example to combine these snapshot models is to simply do majority voting. This allows each model to make a prediction and if over half of the models agree on one class, that is the class assigned to the image. However, this method might not work well with this data and the performance actually decreased by 1 correct animal prediction compared to the single best model. Likely this is due to the individual models not being very confident in their predictions. Another example may average the predictions which shows a noticeable increase in performance. In some examples, the ensemble averaging procedure involves allowing each of the 11 models to make a prediction on each image within a single brain; subsequently, those 11 predictions' softmax outputs are averaged and the class with the highest average confidence is applied to that image. After all the images of a single brain are classified, the majority criteria approach classifies that brain as either high or low proliferation. This snapshot ensemble averaging method may correctly predict the global class (high or low proliferation) of microglial cells in 78.6% of the cases (i.e., 11 of 14 correct). This result for the snapshot ensemble method is based on training with microglial cell densities in local (20×) images with all images assigned a global label regardless of individual image characteristics. Table 1 summarizes the performance of the single best model, ensemble voting, and ensemble averaging methods.

TABLE 1
Results for n = 14 mouse brain predictions

| | Accuracy | Precision | Recall | F1 |
|---|---|---|---|---|
| Method (%) | (%) | (%) | (%) | (%) |
| Single Best | 57.1 | 55.6 | 71.4 | 62.5 |
| Ensemble Voting | 50.0 | 50.0 | 85.7 | 62.9 |
| Ensemble Average | 78.6 | 75.0 | 85.7 | 80.0 |

Current methods for assessing microglial cell proliferation (neuroinflammation) in specific regions of brain and spinal cord require an extensive degree of manual cell counting by a trained expert. As this approach is subjective, error prone, time- and labor-intensive, there is a substantial opportunity for the use of machine learning to automate this process, and thereby accelerate the rate of scientific research, medical discoveries and drug discovery related to neuroinflammation. In some examples, the automatic segmentation of these cells is used at high magnification that can be used to estimate cell counts. These methods may use a human-in-the-loop in one form or another. This is the first application of deep learning to this classification problem at low magnification (20×). Here, a method of using an ensemble of snapshots is presented to automatically classify mouse brains as having high or low density of cells based on the classification of images at 20× magnification with minimal expert time requirement. In the examples, a novel dataset of 14 mice that our method can correctly classify 80% of cases. The example method could provide researchers with quick and accurate estimates of cell density at low magnification. This approach could potentially benefit a wide variety of studies across the diverse disciplines of neuroscience where global proliferation of microglial cells in brain and spinal cord tissue could be predicted after testing with unlabeled low magnification images of immunostained microglia cells on sections from those tissues.

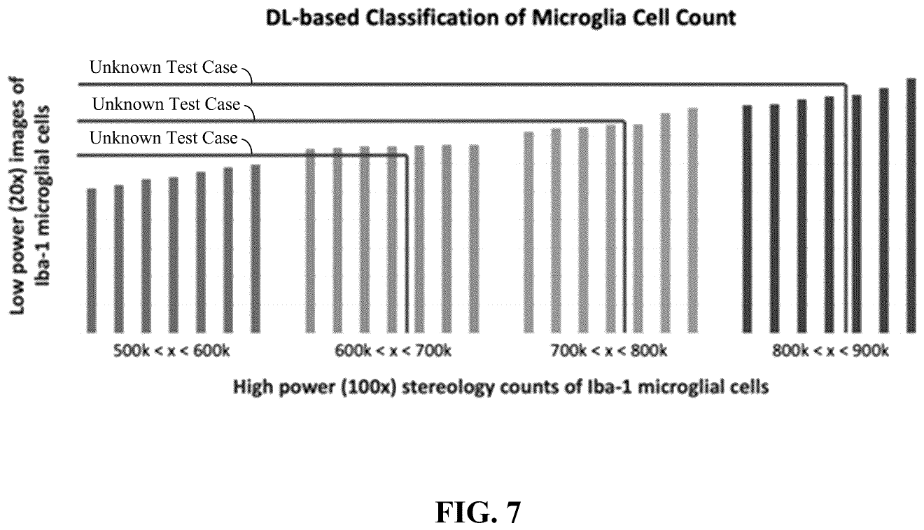

For training the neural network for more than two classes (e.g., three classes, four classes, six classes, etc.), the inventors split 28 cases into the following 4 bins based on their total microglia count in NCTX by manual stereology at 100×: 500 k<X<600 k, 600 k<X<700 k, 700 k<X<800 k, 800 k<X<900 k as seen in FIG. 7. FIG. 7 is an illustration of unknown test case stereology count estimation at 20× magnification based on the number of cells sorted into bins of ground truth stereology count at 100× magnification. This resulted 4 classes with 7 animals or 7 sets of number of cells per class. The 20× images were used for training the CNN and all 20× images from a case received the label based on the global count at 100×. Prior to training, all training data was augmented using two elastic deformations followed with rotation by 90, 180, and 270 degrees as described in connection with FIG. 3. This resulted in twelve times (12×) the original number of training images. Training was done using a leave one out strategy; therefore the network was trained 7 times. Each time 6 animals per class were used for training with 1 case left out for testing. In further examples, due to the imbalance in the number of images per class, per fold, class weights can be computed as shown in equation below where T is total number of training images, C is number of classes, and Xᵢ is number of training images with class i. Then, those can be used to weight the loss function. Equation: CWᵢ=T/(C*Xi).

Once training was complete the inventors had 11 snapshot models per fold (e.g., per animal) for use in testing. In each fold one animal from each class was left out, all the images from each of these animals were run through the 11 snapshot models, and the predictions from these models averaged per image to produce a class for that image. This was repeated for all images of a single animal, the final class (number bin) for that animal was the class for the majority of its images. This method accounts for the fact that the 20× images were taken at different systematic random locations than the 100× images used to generate the ground truth counts. The estimated count was then assigned based on the classification of each case into one of the four bins. The four possible estimated count values for a case were 550 k, 650 k, 750 k, or 850 k. These values were then compared to the ground truth counts from 100× to determine the performance.

A total of 28 animals in this study were manually counted at 100× to obtain the total number of microglia in the NCTX. As described, one animal was left out of training in one of the 7 folds, and a count prediction was made using the above procedure. Each animal was given one of four predicted counts (550 k, 650 k, 750 k, or 850 k) for the total number of microglia in the NCTX. These estimated values were compared with the ground truth count at 100× for each animal to obtain the count error rates and accuracy. The error in count was computed using an equation

$$( Error = \frac{\vert G - P \vert}{G} ) ,$$

where G is the ground truth count and P is the predicted count. The example method disclosed herein showed an average error rate of 7.12% with a standard deviation of 6.58% for the n=28 cases, meaning the average count accuracy was about 93% accurate (92.88%). The error rate and accuracy per fold are shown in Table 2 Overall for the 28 cases the total number cells counted by the expert was ˜19.5 million, whereas the total number of cells predicted by our method was 18.9 million, this results in an error rate of 3.52% overall, for an overall accuracy for all counts of about 96.48%. Classification of test cases required ˜5 minutes/case of supervised time and ˜20 minutes of unsupervised time to collect an average of 225 images at low mag (total time ˜30 mins).

TABLE 2
Average Per Fold Results

| Fold | Accuracy (%) | Error Rate (%) |
|---|---|---|
| 1 | 95.38 | 4.63 |
| 2 | 92.38 | 7.62 |
| 3 | 92.01 | 7.99 |
| 4 | 96.69 | 3.31 |
| 5 | 92.48 | 7.52 |
| 6 | 93.32 | 6.68 |
| 7 | 87.89 | 12.11 |

The disclosed custom CNN can automatically classify mouse brains based on total number of microglia in the NCTX using 20× images with an average error of 7.12% or accuracy of 92.88%. This is in comparison to human counting which demonstrates an inter- and intra-rater accuracy of 81.41% and 80.33% respectively on low magnification 40× images. The disclosed method does not rely on segmentation for counting and thus does not need labor-intensive ground truth for training. The disclosed method and system only use the ground truth counts at 100×; however, once trained the model can make accurate and 100% reproducible (Test-Retest) counts in less than one minute per case. The ability of the disclosed method to use low-mag 20× images reduces the time needed to collect images (˜20 minutes per case). The disclosed method and system have the ability to provide neuroscience researchers with accurate and reproducible counts without the need of human data collectors, which in effect can accelerate the pace for research studies based on number of microglial cells on tissue sections. With the dataset of low-mag images from 28 cases, the inventors can provide total microglial cell counts in NCTX in ˜28 minutes versus over 28 hours of labor-intensive manual counting (clicking) for a trained human to do the same with similar error rates, i.e., a 98% reduction in time.

In further examples, the disclosed method and system can be used for immunofluorescent-stained images of microglia, other brain cells (astrocytes, neurons), and automatic classification of microglial cell morphology. It should be appreciated that the disclosed method can be used for any other suitable cells, any microstructures, or any biological objects or interests (e.g., amyloid deposit, neurofibrillary tangles, Lewy bodies, etc.). In further examples, the disclosed method and system can be used for screening outliers in drug use cases or other samples, which are above or below one or more predetermined thresholds, or diagnosing cancer diseases or any diseases.

For example, the disclosed method and system can be used for automatic classification of number and morphology ratings of multinucleated giant cells (MGCs). In some scenarios, the automatic classification of number and morphology ratings are for immunofluorescent-stained (IF)- and immunohistochemistry (IHC)-labeled MGCs in neocortex (NCTX) and hippocampus (HPC) in the trimethyltin (TMT) model of neurotoxicity. In the examples, ground truth data can be collected at high magnification (e.g., 60×) using a stereology system and expert morphology ratings for counted MGCs into 4 classes using a published 4-point rating scale for MGC activation state.

For model training for classification of IF- and IHC-labeled MGCs, ˜150-300 low mag (20×) images of IF- and IHC-labeled MGCs can be augmented. Then, the disclosed models can be trained, validated, and tested. Test images not used for training can be fed into the DL models for automatic predictions of total counts (4 bins) and morphology ratings (4-point scale) of MGCs at the region of interest (ROI) level. The classification of low-mag images to their corresponding GT counts at high mag does not require time- and labor-intensive segmentation GT for training the model. A customized ensemble of networks obtained with the snapshot method can be used to train a single time, save intermediate models, and take the highest mean class as prediction. The same approach can used to classify Morphology Ratings. That is, raters will be trained and supervised by domain experts to score IF- and IHC-labeled MGCs for morphological phenotypes based on several factors such as relative distribution of cells in each ROI, e.g., relative to expected “nearest neighbor” spacing of ˜50 μm with well-ramified processes in multiple directions between cells in surveillance mode (rating 4). Microglial activation (ratings 2-3) reflects changes associated with brain injury: hypertrophy or atrophy relative to expected microglia soma size (˜1-3 μm) with MGCs showing more rod-like shapes with fewer and shorter processes as evidenced by reduced IHC staining between soma and diminished microglial processes. The phagocytosis phenotype (rating 1) refers to elongated, “lumpy”, and ameboid soma with most processes extending in one direction and non-uniform cell distributions, few or no processes or ramifications between cells, and markedly reduced fiber length. The mean % distribution of cells with each score can be computed for NCTX and HPC.

In conclusion, the disclosed DL-based classification approach can automatically classify the number and morphology of IHC-labeled MGCs using 4 number bins and 4-point morphology ratings. The value of classification is that once models are established at high magnification, classification into number and morphology bins only requires ˜200 low-mag images through each ROI. Applications of this approach to animal models of neurotoxicity can accelerate research by avoiding the need for tedious, labor- and time-consuming manual stereology counts and qualitative morphology assessments.

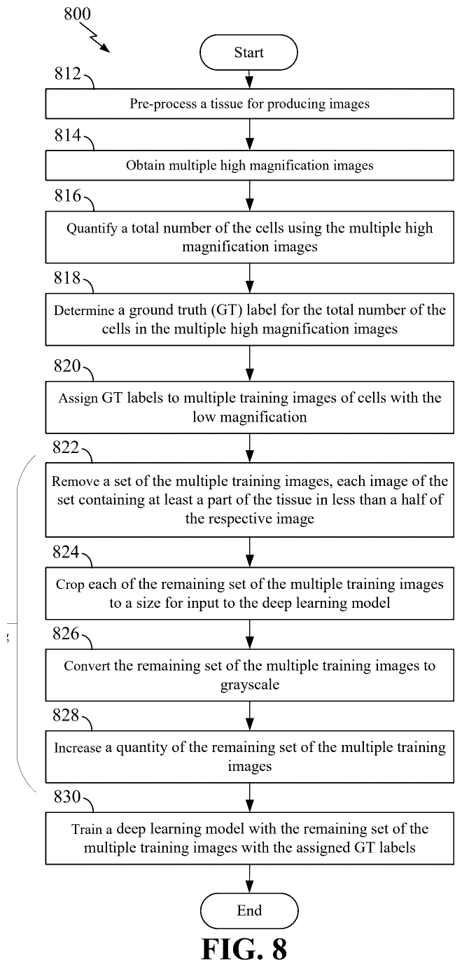

FIG. 8 is a flow chart illustrating an example process for training a deep learning model for computerized classification in accordance with some aspects of the present disclosure. As described below, a particular implementation may omit some or all illustrated features and may not require some illustrated features to implement all embodiments. In some examples, any suitable apparatus or means for carrying out the functions or algorithm described below may carry out the process 800.

In block 812, a tissue can be pro-processed for producing multiple images. For example, an animal tissue (e.g., a neocortex) can be cut into serial 40 μm-thick sections. The sections can be stained to label cells in the sections. In some examples, standard Iba-1 immunostaining can be used to stain the sections.

In block 814, the apparatus may obtain multiple high magnification images with a high magnification, such as higher than 60× using a microscope. Magnification may be broken up into two parts the objective lens and the optical lens. The optical lens for most microscopes is constant at 10×. In some examples, the high magnification for the tissue to be anything equal to or higher than a 60× objective lens. The total magnification is the objective multiplied by the optical lens, for a total of 600× and up. Some examples in this disclosure use a 100× objective lens, with a 10× optical lens, which would be a total of 1000× magnification.

In block 816, the apparatus may receive the total number of the stained cells of the tissue in one or more high magnification images. In some examples, the apparatus may receive multiple sets of total numbers of the stained cells for the same types of tissue in multiple corresponding sets of one or more high magnification images. In some examples, one high magnification image can include the total number of cells for the tissue. In other examples, multiple high magnification images as a whole can include the total number of cells for the tissue. In some examples, an expert technician uses the manual version of the unbiased optical fractionator in a computerized stereology system to quantify the total number of stained cells in the multiple high magnification images. Then, the expert technician may insert the total number of training cells in the apparatus, and the apparatus may receive the total number of cells.

In block 818, the apparatus may determine or receive a ground truth (GT) label for the total number of the cells in each of the multiple sets of one or more multiple high magnification images. In some examples, the GT label is indicative of high proliferation or low proliferation of the total number of the cells. The GT label is produced by counting the cells at high magnification and determining relatively high or low cases. In some examples, this counting is done by an expert technician using a computerized stereology system by clicking on cells to be counted. For determining high or low proliferation level, some examples may determine levels based on the data. For example, a number of cases are counted and sorted. The ones at the extremes may be considered as high and low. In some examples, an average of the total numbers of cells in the multiple high magnification images can be a threshold to determine the high proliferation and the low proliferation of cells in a runtime image. In other examples, a middle number between the highest total number of cells and the lowest total number of cells among the multiple high magnification images can be the threshold. In further examples, the threshold can be empirically or manually determined. The deep learning model can determine the level of proliferation of a runtime image based on low magnification images trained with the high and low proliferation labels in the multiple high magnification images. In some examples, the results were that the ranges were 405,200 to 452,550 for low cases and for the high cases from 638,670 to 714,740 number of cells. For example, if 100 samples for the cells exist, a predetermined number (e.g., 7 samples or 10% samples having the highest number of cells) of samples having the highest proliferation can be labeled as high proliferation while a predetermined number (e.g., 7 samples or 10% samples having the lowest number of cells) of samples having the lowest proliferation can be labeled as low proliferation.

In other examples, the GT label may indicate one of more than two proliferation levels (e.g., three, four, five, etc.). For examples, the number of proliferation levels can be four. The four proliferation levels corresponding to four GT labels can be determined by the training images. In some examples, the range of total number of cells in the training images can be equally divided by four. In other examples, each range or bin of total number of cells for a proliferation level can be determined based on a predetermined range (e.g., 100 k) of total number of cells for a tissue. For example, a first bin of training images corresponds to a first ground truth label and a first proliferation level, and the total number of cells in each image in the first bin is between 500 k and 600 k. A second bin of the training images corresponds to a second ground truth label and a second proliferation level, and the total number of cells in each image in the second bin is between 600 k and 700 k. A third bin of the training images corresponds to a third ground truth label and a third proliferation level, and the total number of cells in each image in the third bin is between 700 k and 800 k. A fourth bin of the training images corresponds to a fourth ground truth label and a fourth proliferation level, and the total number of cells in each image in the fourth bin is between 800 k and 900 k. In further examples, each range of total number of cells for a proliferation level can be determined based an error rate. For example, if the total number of cells is 1,000,000 and an error rate is 10%, each range of total number of cells for a proliferation level should be more than 100,000 to produce a meaningful proliferation level.

In block 820, the apparatus may assign the GT label of each set of multiple sets of one or more high magnification images to a corresponding training image of multiple training images for the issue. Each training image of the multiple training images is at a low magnification equal to or lower than a 40× objective lens. Thus, at low magnification, all training images collected are assigned corresponding GT labels given to the tissue based on high magnification count regardless of their individual characteristics. The apparatus may automatically collect the training images at a low magnification in a systematic-random set of selection.

In blocks 822-828, the apparatus may pre-process the training images. For example, in block 822, the apparatus may remove a set of the training images. For example, the training images are a superset of training images including a first set and a second set of training images. Each training image of the second set of training images may contain at least a part of the tissue in less than a half of the respective image. Thus, the apparatus may remove the second set of the training images, which contains at least a part of the tissue in less than a half of each training image. The first set of training images may be the remaining images after removing the second set of the superset of training images. This may include color thresholding to remove the second set of the training images that contain less than 50% tissue in frame of the training images. In some examples, the block 820 to assign the GT label to training images may be performed after the process of block 822. Thus, the apparatus may assign the GT label to a smaller number of training images than before removing the second set of training images.

In block 824, the apparatus may crop each training image of the first set of the training images to a predetermined size for input to the deep learning model. For example, the apparatus may crop and center each training image of the first set of the training images to a predetermined size of 512×512 pixels for input to the deep learning model (e.g., the convolutional neural network (CNN)). Here, However, it should be appreciated the size is not limited to 512×512. It may by any other suitable image size for input to the deep learning model. Here the deep learning model may be a CNN. However, the deep learning model is not limited to a CNN. It could be Multi-Layer Perceptrons (MLP) or Recurrent Neural Networks (RNN).

In block 826, the apparatus may convert the first set of training images to grayscale. For example, the apparatus may convert the first set of training images from RGB to grayscale using a correlation-based approach.

In block 828, the apparatus may increase a quantity of the first set of training images. For example, to increase a quantity of the first set of training images, the apparatus may augment the first set of lo training images with two elastic deformations and rotation by 90, 180, or 270 degrees.

In block 830, the apparatus may train a deep learning model based on the preprocessed first set of training images with the corresponding GT labels to produce a proliferation level of a total number of cells in an image at the low magnification image equal to or lower than the 40× objective lens.

In some examples, the deep learning model includes a convolution layer, the convolution layer using rectified linear unit (ReLU) activation. In further examples, the deep learning model includes two fully connected layers using rectified linear unit (ReLU) activation with a weight to decay towards zero. Thus, the two fully connected layers may use ReLU with the addition of L2 regularization. In addition, the deep learning model may use a softmax function for normalization. Also, the deep learning model may use Stochastic Gradient Descent (SGD) for optimization. The deep learning model may exclude a VGG16 deep learning model or a DenseNet deep learning model.

In further examples, the deep learning model may include, but is not limited to, a first convolution layer with 8 filters, each filter having a kernel size of 3×3, a second convolution layer with 16 filters, each filter having a kernel size of 3×3, a first pooling layer between the first convolution layer and the second convolution layer, a third convolution layer with 32 filters, each filter having a kernel size of 5×5, a fourth convolution layer with 64 filters, each filter having a kernel size of 5×5, a second pooling layer between the third convolution layer and the fourth convolution layer, a first dense layer with a depth of 64, a first dropout layer with a rate of 0.5, a second dense layer with a depth of 128, a second dropout layer with a rate of 0.5, and a third dense layer with two output values using a softmax activation function to output the proliferation level.

In some examples, the deep learning model may include multiple snapshots with corresponding model weights. For example, at the end of each training cycle of the deep learning model, the apparatus may take a snapshot with a respective model weight. After training multiple cycles, the apparatus may obtain multiple corresponding snapshots. In some examples, an ensemble snapshot of the multiple snapshots may combine the multiple snapshots by doing majority voting of multiple outputs (proliferation levels) of the multiple snapshots. In other examples, an ensemble snapshot of the multiple snapshots may combine the multiple snapshots by averaging multiple outputs (proliferation levels) of the multiple snapshots. Thus, the apparatus may classify the total number of cells in the issue as a proliferation level based on the ensemble of multiple snapshots. In some examples, the snapshot ensemble may be used in a training phase and/or a runtime phase. In the training phase, intermediate models can be saved as the network is training. These intermediate models are then used in testing where each of the intermediate models makes a prediction on a single image, those predictions are averaged, and a final class is determined.

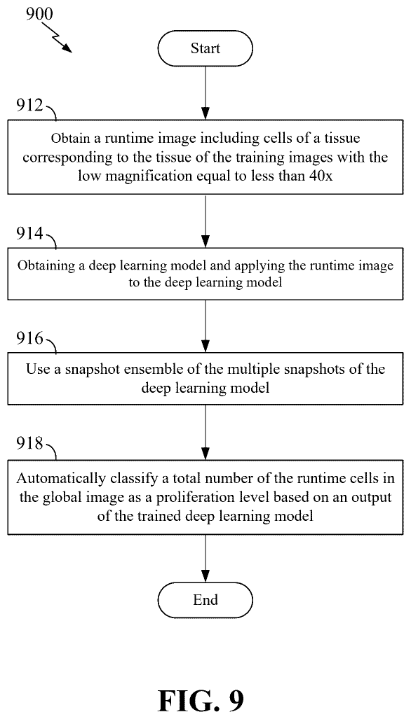

FIG. 9 is a flow chart illustrating an example process for computerized classification using a trained deep learning model in accordance with some aspects of the present disclosure. As described below, a particular implementation may omit some or all illustrated features and may not require some illustrated features to implement all embodiments. In some examples, any suitable apparatus or means for carrying out the functions or algorithm described below may carry out the process 600.

In block 912, the apparatus may obtain a runtime image (multiple images) including cells of a tissue corresponding to the tissue used in the training phase with the low magnification. Here, the low magnification may be equal to or less than 40×. While the process 800 expounds the pre-processing of images and training a deep learning model, the process 900 illustrates a runtime process. Thus, the process 900 uses one or more runtime images of a tissue. The tissue in the runtime phase is the same type as the tissue in the training phase of the deep learning model.

In block 914, the apparatus may obtain a deep learning model and apply the runtime image to the deep learning model. In some examples, the deep learning model may have been trained with multiple training images of cells of a tissue with a low magnification equal to or less than a 40× objective lens. The tissue in the training phase corresponds to the tissue of the runtime image. Each of the multiple training images may have a ground truth label based on a total number of the cells on each of the multiple training images counted with one or more high magnification images at a high magnification equal to or higher than a 60× objective lens.

In some examples, the deep learning model may include a convolution layer, the convolution layer using rectified linear unit (ReLU) activation. In further examples, two fully connected layers of the deep learning model may use rectified linear unit (ReLU) activation with a weight to decay towards zero. In further examples, the deep learning model may use a softmax function for normalization. In further examples, the deep learning model may include a first convolution layer with 8 filters, each filter having a kernel size of 3×3, a second convolution layer with 16 filters, each filter having a kernel size of 3×3, a first pooling layer between the first convolution layer and the second convolution layer, a third convolution layer with 32 filters, each filter having a kernel size of 5×5, a fourth convolution layer with 64 filters, each filter having a kernel size of 5×5, a second pooling layer between the third convolution layer and the fourth convolution layer, a first dense layer with a depth of 64, a second dense layer with a depth of 128, and a third dense layer with two output values using a softmax activation function to output the proliferation level. In further examples, the deep learning model further includes: a first dropout layer with a rate of 0.5, and a second dropout layer with a rate of 0.5. In further examples, the softmax activation function is configured to output the proliferation level of the total number of the second cells in the runtime image between a first proliferation level and a second proliferation level. In further examples, the softmax activation function is configured to output the proliferation level of the total number of the second cells in the runtime image among a first proliferation level, a second proliferation level, a third proliferation level, and a fourth proliferation level. In further examples, each of the first convolution layer, the second convolution layer, the third convolution layer, and the fourth convolution layer may use rectified linear unit (ReLU) activation.

In block 916, the apparatus may use a snapshot ensemble of the multiple snapshots of the deep learning model. As described above, an ensemble snapshot of the multiple snapshots may combine the multiple snapshots by doing majority voting of multiple outputs (proliferation levels) of the multiple snapshots. In other examples, an ensemble snapshot of the multiple snapshots may combine the multiple snapshots by averaging multiple outputs (proliferation levels) of the multiple snapshots. Thus, the apparatus may classify the total number of cells in the issue as a proliferation level based on the ensemble of multiple snapshots. In some examples, the proliferation level is low or high. In further examples, the proliferation level is one of more than to proliferation levels (e.g., low, high, and medium).

In block 918, the apparatus may automatically classify the total number of cells in the runtime image as the proliferation level based on the ensemble snapshot of block 914. Therefore, the apparatus can train a deep learning model with low magnification images (20×) of multiple cells using a snapshot ensemble of deep learning models to classify the proliferation level of the total number of cells in the tissue. Once the model has been trained, the intermediate models may be saved. In the runtime, the runtime 20× images for a tissue may be used. In the runtime, each of the intermediate models may make a prediction. Those predictions are then averaged, and the class of high or low is assigned for that image. The animal's class depends on which class the majority of the images from that animal are classified as. For example, if more than 50% of the images from a single mouse are predicted as low it is considered low while if more than 50% of the images from a single mouse are predicted as high it is considered high. The deep learning model classify each image as belonging to low or high total numbers of cells at the global level in the tissue without the need for human-in-the-loop training, cell-level segmentation, or manual stereology at high magnification. In some examples, the global level may refer to the global label that is given per animal after it is counted at a high magnification (e.g., 100×). At the high magnification, the cells are counted, and it is given a global label of either high or low density. The animal tissue is then re-imaged at a low magnification (e.g., 20×), and that global label is given to every log magnification image of that animal regardless of the individual appearance. So, the global level class is either high or low, but every image at the low magnification may not appear to the eye to follow the global label as they vary in individual characteristics. Because the approach requires little effort or technical expertise by the data collector, it has the potential to accelerate the throughput of microglial proliferation studies in many scientific disciplines.

In some examples, the proliferation level is a first proliferation level (e.g., low proliferation) or a second proliferation level (e.g., high proliferation) of the total number of the cells in the runtime image. In other examples, the proliferation level is a first proliferation level, a second proliferation level, a third proliferation level, or a fourth proliferation level of the total number of the cells in the runtime image.

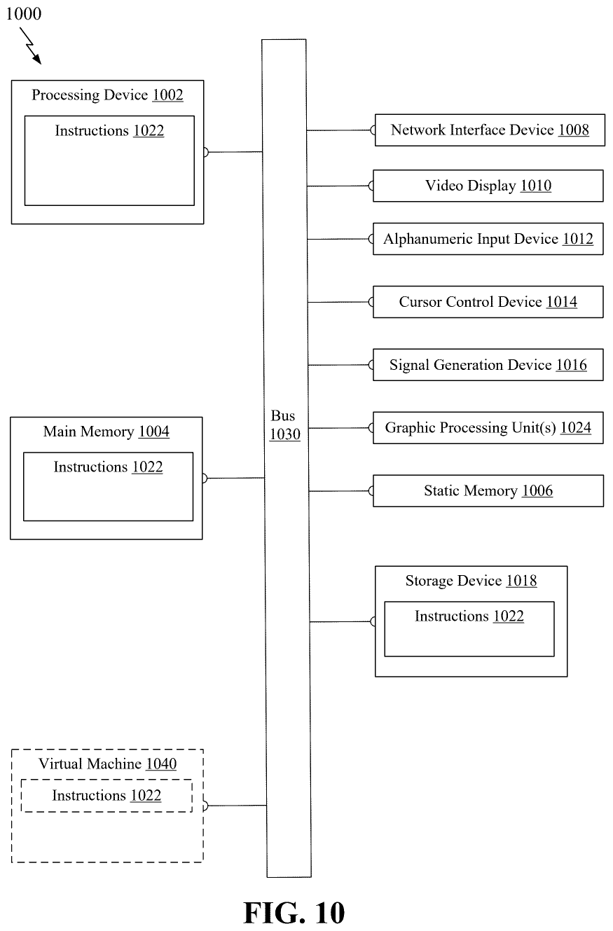

FIG. 10 is a block diagram conceptually illustrating an example apparatus of a computer system 1000 within which a set of instructions, for causing the apparatus to perform any one or more of the methods disclosed herein, may be executed. In alternative implementations, the apparatus may be connected (such as networked) to other apparatus in a LAN, an intranet, an extranet, and/or the Internet.

The apparatus may operate in the capacity of a server or a client machine in a client-server network environment, as a peer machine in a peer-to-peer (or distributed) network environment, or as a server or a client machine in a cloud computing infrastructure or environment. The apparatus may be a server computer, a personal computer (PC), a tablet PC, a set-top box (STB), a Personal Digital Assistant (PDA), a cellular telephone, a web appliance, a server, a network router, a switch or bridge, or any apparatus capable of executing a set of instructions (sequential or otherwise) that specify actions to be taken by that apparatus. Further, while a single apparatus is illustrated, the term “apparatus” shall also be taken to include any collection of apparatuses that individually or jointly execute a set (or multiple sets) of instructions to perform any one or more of the methods discussed herein.

The example computer system 1000 includes a processing device 1002, a main memory 1004 (such as read-only memory (ROM), flash memory, dynamic random access memory (DRAM) such as synchronous DRAM (SDRAM) or DRAM, etc.), a static memory 1006 (such as flash memory, static random access memory (SRAM), etc.), and a data storage device 1018, which communicate with each other via a bus 1030.

Processing device 1002 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions 1022 for performing the operations and steps discussed herein.

The computer system 1000 may further include a network interface device 1008 for connecting to the LAN, intranet, internet, and/or the extranet. The computer system 1000 also may include a video display unit 1010 (such as a liquid crystal display (LCD) or a cathode ray tube (CRT)), an alphanumeric input device 1012 (such as a keyboard), a cursor control device 1014 (such as a mouse), a signal generation device 1016 (such as a speaker), and a graphic processing unit 1024 (such as a graphics card).

The data storage device 1018 may be a machine-readable storage medium 1028 (also known as a computer-readable medium) on which is stored one or more sets of instructions or software 1022 embodying any one or more of the methods or functions described herein. The instructions 1022 may also reside, completely or at least partially, within the main memory 1004 and/or within the processing device 1002 during execution thereof by the computer system 1000, the main memory 1004 and the processing device 1002 also constituting machine-readable storage media.

In one implementation in the generator, the instructions 1022 include, at a training phase, obtaining multiple high magnification images, quantifying a total number of the cells using a multiple high magnification images, determining a ground truth label for the total number of the cells in the multiple high magnification images, assigning the GT label to multiple local images of cells with the low magnification, removing a set of multiple local images, cropping each of the remaining set of the multiple local images, converting the remaining set of the multiple local images to grayscale, increasing a quantity of the remaining set of the multiple local images, and/or training a deep learning model with the remaining set of the multiple local images with the assigned GT label at blocks 812, 814, 816, 818, 820, 822, 824, 826, 828, and/or 830 of FIG. 8. The instructions 1022 may further include, at a runtime phase, obtaining a runtime image including cells of a tissue corresponding to the tissue in the training phase with the low magnification equal to less than 40×, using a snapshot ensemble of the multiple snapshots of the deep learning model, and/or automatically classifying a total number of the cells in the runtime image as a proliferation level based on an output of the trained deep learning model at blocks 912, 914, and/or 916 of FIG. 9.

While the machine-readable storage medium 1018 is shown in an example implementation to be a single medium, the term “machine-readable storage medium” should be taken to include a single medium or multiple media (such as a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media. The term “machine-readable storage medium” shall accordingly exclude transitory storage mediums such as signals unless otherwise specified by identifying the machine-readable storage medium as a transitory storage medium or transitory machine-readable storage medium.

In another implementation, a virtual machine 1040 may include a module for executing instructions similarly described above in connection with instructions 1022. In computing, a virtual machine (VM) is an emulation of a computer system. Virtual machines are based on computer architectures and provide functionality of a physical computer. Their implementations may involve specialized hardware, software, or a combination of hardware and software.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “modifying” or “providing” or “calculating” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices. The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (such as a computer). For example, a machine-readable (such as computer-readable) medium includes a machine (such as a computer) readable storage medium such as a read only memory (“ROM”), random access memory (“RAM”), magnetic disk storage media, optical storage media, flash memory devices, etc.

The disclosure may be further understood by way of the following examples:

Example 1: A method, apparatus, and non-transitory computer-readable medium for automatic classification comprises: obtaining a deep learning model, the deep learning model having been trained with a plurality of training images of cells of a first tissue with a low magnification equal to or less than a 40× objective lens, each of the plurality of training images having a ground truth label based on a first total number of the cells on each of the plurality of training images counted with one or more high magnification images at a high magnification equal to or higher than a 60× objective lens; applying a runtime image including second cells of a second tissue corresponding to the first tissue with the low magnification in the deep learning model; and automatically classifying a second total number of the cells in the runtime image as a proliferation level based on an output of the deep learning model.

Example 2: The method, apparatus, and non-transitory computer-readable medium according to Example 1, wherein the deep learning model includes a plurality of snapshots with corresponding model weights, and wherein the second total number of cells in the runtime image is classified as the proliferation level by using a snapshot ensemble of the plurality of snapshots.

Example 3: The method, apparatus, and non-transitory computer-readable medium according to Example 1 or 2, wherein the snapshot ensemble combines the plurality of snapshots by doing majority voting of a plurality of proliferation levels of the plurality of snapshots to produce the proliferation level.

Example 4: The method, apparatus, and non-transitory computer-readable medium according to any of Examples 1-3, wherein the snapshot ensemble combines the plurality of snapshots by averaging a plurality of proliferation levels of the plurality of snapshots to produce the proliferation level.

Example 5: The method, apparatus, and non-transitory computer-readable medium according to any of Examples 1-4, wherein the proliferation level is a first proliferation level or a second proliferation level of the second total number of the cells in the runtime image.

Example 6: The method, apparatus, and non-transitory computer-readable medium according to any of Examples 1-5, wherein the proliferation level is a first proliferation level, a second proliferation level, a third proliferation level, or a fourth proliferation level of the second total number of the cells in the runtime image.

Example 7: The method, apparatus, and non-transitory computer-readable medium according to any of Examples 1-6, wherein the deep learning model comprises a convolution layer, the convolution layer using rectified linear unit (ReLU) activation.

Example 8: The method, apparatus, and non-transitory computer-readable medium according to any of Examples 1-7, wherein two fully connected layers of the deep learning model uses rectified linear unit (ReLU) activation with a weight to decay towards zero.

Example 9: The method, apparatus, and non-transitory computer-readable medium according to any of Examples 1-8, wherein the deep learning model uses a softmax activation function for normalization.

Example 10: The method, apparatus, and non-transitory computer-readable medium according to any of Examples 1-9, wherein the softmax activation function is configured to output the proliferation level of the second total number of the second cells in the runtime image is between a first proliferation level and a second proliferation level.

Example 11: The method, apparatus, and non-transitory computer-readable medium according to any of Examples 1-10, wherein the softmax activation function is configured to output the proliferation level of the second total number of the second cells in the runtime image among a first proliferation level, a second proliferation level, a third proliferation level, and a fourth proliferation level.

Example 12: The method, apparatus, and non-transitory computer-readable medium according to any of Examples 1-11, wherein the deep learning model comprises: a first convolution layer with 8 filters, each filter having a kernel size of 3×3, a second convolution layer with 16 filters, each filter having a kernel size of 3×3, a first pooling layer between the first convolution layer and the second convolution layer, a third convolution layer with 32 filters, each filter having a kernel size of 5×5, a fourth convolution layer with 64 filters, each filter having a kernel size of 5×5, a second pooling layer between the third convolution layer and the fourth convolution layer, a first dense layer with a depth of 64, a second dense layer with a depth of 128, and a third dense layer with two output values using a softmax activation function to output the proliferation level.

Example 13: The method, apparatus, and non-transitory computer-readable medium according to any of Examples 1-12, wherein the deep learning model further comprises: a first dropout layer with a rate of 0.5, and a second dropout layer with a rate of 0.5.

Example 14: The method, apparatus, and non-transitory computer-readable medium according to any of Examples 1-13, wherein each of the first convolution layer, the second convolution layer, the third convolution layer, and the fourth convolution layer use rectified linear unit (ReLU) activation.

Example 15: A method, apparatus, and non-transitory computer-readable medium for automatic classification training comprises: obtaining a plurality sets of one or more high magnification images at a high magnification equal to or higher than a 60× objective lens; quantifying a first total number of cells in a tissue in each set of the plurality sets; receiving a ground truth (GT) label for the first total number of the cells in each set of the plurality sets; assigning the GT label in each set of the plurality sets to a respective training image of a plurality of training images, each of the plurality of training images being at a low magnification equal to or lower than a 40× objective lens; and training a deep learning model with the plurality of training images with the corresponding GT labels to produce a proliferation level of a second total number of cells in an image at the low magnification equal to or lower than the 40× objective lens.

Example 16: The method, apparatus, and non-transitory computer-readable medium according to any of Example 15, wherein the GT label is indicative of a first proliferation level or a second proliferation level of the first total number of the cells in the corresponding training image.

Example 17: The method, apparatus, and non-transitory computer-readable medium according to Example 15 or 16, further comprising: preprocessing the plurality of training images, wherein preprocessing the plurality of training images comprises: obtaining a superset of the plurality of training images, the superset including a first set and a second set of training images, the first set corresponding to the plurality of training images; removing the second set of training images, each training image of the second set containing at least a part of the tissue in less than a half of the respective training image; cropping each of the first set of training images to a predetermined size for an input to the deep learning model; and converting the first set of the plurality of training images to grayscale.

Example 18: The method, apparatus, and non-transitory computer-readable medium according to any of Example 15-17, further comprising: increasing a quantity of the plurality of training images with two elastic deformations and rotation by 90, 180, or 270 degrees.

Example 19: The method, apparatus, and non-transitory computer-readable medium according to any of Examples 15-18, wherein the proliferation level of the second total number of cells in the image at the low magnification equal to or lower than the 40× objective lens is a first proliferation level or a second proliferation level.

Example 20: The method, apparatus, and non-transitory computer-readable medium according to any of Examples 15-19, wherein the proliferation level of the second total number of cells in the image at the low magnification equal to or lower than the 40× objective lens is a first proliferation level, a second proliferation level, a third proliferation level, or a fourth proliferation level.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for training a convolutional neural network model for classification of characteristics of objects in images taken from varying distances, comprising:
obtaining a plurality of first training images taken from a first distance from the objects;
determining a presence or absence of a characteristic of the objects in each of the plurality of first training images;
obtaining a plurality of second training images that correspond image-to-image with the plurality of first images, but having been taken from a second distance from the objects, the second distance being at least twice the first distance;
ascribing a ground truth (GT) label to each image of the plurality of second training images indicative of the characteristic of the objects, according to whether the characteristic of the objects was present or absent in each corresponding image of the plurality of first training images; and
obtaining a convolutional neural network having at least four convolutional layers, two max pooling layers, three dense layers, two dropout layers, and an output layer utilizing a softmax activation to determine one of two possible outputs; and
training the deep learning model using Stochastic Gradient Descent (SGD) with at least a portion of the plurality of second training images with the GT labels, wherein the input to the convolutional neural network is an image of the objects and the possible outputs are the presence or absence of the characteristic of the objects in the image.
